(19) United States
(12) Patent Application Publication
(10) Pub. No.: US 2021/0309068 A1
(43) Pub. Date: Oct. 7, 2021

(54) ON-VEHICLE EQUIPMENT OPERATION DEVICE

(71) Applicant: Toyota Jidosha Kabushiki Kaisha, Toyota-shi Aichi-ken (JP)

(72) Inventors: Kei Yamamoto, Toyota-shi (JP); Takashi Nishimoto, Owariasahi-shi (JP); Kenji Sato, Toyota-shi (JP)

(21) Appl. No.: 17/215,522

(22) Filed: Mar. 29, 2021

(30) Foreign Application Priority Data
Apr. 1, 2020 (JP) 2020-065657

(51) Int. Cl. B60H 1/00; B60K 37/04; B60H 1/24

(52) U.S. Cl. CPC B60H 1/0055; B60K 37/04; B60K 2370/658; B60K 2370/33; B60H 1/242

(57) ABSTRACT

An on-vehicle equipment operation device includes an air-conditioning duct that has an open end through which air-conditioned air blows, a display that is disposed outside the air conditioner and configured to display an image, an image forming optical element, and at least one equipment operation switch that is disposed at a lower edge of the open end. The image forming optical element is configured to form, as a floating image near the open end of the air-conditioning duct, a real image of the image that is displayed on the display. The floating image includes at least one equipment operation icon. The at least one equipment operation switch corresponds to the at least one equipment operation icon.

### CROSS REFERENCE TO RELATED APPLICATION

This application claims priority to Japanese Patent Application No. 2020-065657 filed on Apr. 1, 2020, which is incorporated herein by reference in its entirety including the specification, claims, drawings, and abstract.

### TECHNICAL FIELD

The present disclosure relates to an on-vehicle equipment operation device that operates equipment installed in a vehicle.

### BACKGROUND

Air blowers have been proposed in which an image of a gauge, such as a speedometer and a tachometer, is displayed on a display, and an optical element forms a floating image of the image displayed on the display in the path of air blown from the on-vehicle air blower (for example, WO 2017/010395 A).

The device disclosed in WO 2017/010395 A can enhance freedom of design of a passenger compartment because no device installation space is required if the path of air blown from an air blower can be used not just as the air blowing path, but also as a display space of an image of a device, such as a gauge.

### SUMMARY

In the conventional art, such as that disclosed in WO 2017/010395 A, while it is possible to conserve space on which vehicle information, such as that from a gauge, is displayed, it is not possible to save space required for operation panels of on-vehicle equipment such as the air conditioner, audio devices, or the like that require operation by an occupant of the vehicle.

Meanwhile, the demand for reduction in space required for operation devices for various types of on-vehicle equipment installed in a passenger compartment in order to enhance freedom of design of a passenger compartment is greater than ever before.

An object of the present disclosure is to reduce space required for installing the on-vehicle equipment operation device.

An on-vehicle equipment operation device according to one embodiment of the present disclosure operates equipment that is installed in a vehicle. The on-vehicle equipment operation device includes an air-conditioning duct that is connected to an on-vehicle air conditioner. The air-conditioning duct includes an open end through which air-conditioned air from the air conditioner blows into a passenger compartment. The on-vehicle equipment operation device also includes a display that is disposed outside the air conditioner and configured to display an image, and an image forming optical element that is attached to the air-conditioning duct. The image forming optical element forms, as a floating image near the open end of the air-conditioning duct, a real image of the image that is displayed on the display. The on-vehicle equipment operation device further includes at least one equipment operation switch that is disposed at a perimeter of the open end of the air-conditioning duct. The floating image includes at least one equipment operation icon. The at least one equipment operation switch corresponds to the at least one equipment operation icon.

In the on-vehicle equipment operation device, the floating image that includes at least one equipment operation icon is formed near the open end of the air-conditioning duct, and the at least one equipment operation switch that corresponds to the at least one equipment operation icon is disposed at the perimeter of the open end. Thus, because the space required for displaying the equipment operation icons and the space required for disposing the open end of the air-conditioning duct are used in common, the space required for the on-vehicle equipment operation device can be reduced.

In the on-vehicle equipment operation device according to one embodiment of the present disclosure, the floating image may include multiple equipment operation icons. The at least one equipment operation switch may be multiple equipment operation switches that are disposed at the perimeter of the open end of the air-conditioning duct. The multiple equipment operation switches may correspond to the multiple equipment operation icons respectively.

The above configuration can effectively save the space required for the on-vehicle equipment operation device.

In the on-vehicle equipment operation device according to one embodiment of the present disclosure, the open end of the air-conditioning duct may has a transversely-elongated slit shape. The equipment operation switches may be disposed in a line along an upper or lower edge of the open end.

The above configuration can improve operability of the respective equipment operation switches.

In the on-vehicle equipment operation device according to one embodiment of the present disclosure, the air-conditioning duct may include a translucent wall that includes a translucent member. The image forming optical element may be disposed on an outer surface of the translucent wall. The display may be disposed adjacent to and on a vehicle rear side of the image forming optical element such that the display defines an angle with an outer surface of the air-conditioning duct.

With the above configuration, because the image forming optical element and the display are disposed outside the air-conditioning duct, deterioration of the image forming optical element and the display due to a temperature change or humidity in the air-conditioned air can be reduced.

In the on-vehicle equipment operation device according to one embodiment of the present disclosure, the image forming optical element may be part of a wall of the air-conditioning duct.

The above configuration can achieve a simple configuration.

In the on-vehicle equipment operation device according to one embodiment of the present disclosure, the open end of the air-conditioning duct may be disposed at an instrument panel at a front portion of the passenger compartment. The display may be disposed behind the front instrument panel. The at least one equipment operation switch may be disposed at the instrument panel at the perimeter of the open end.

The above configuration can further conserve space required for disposing the equipment operation icons on the front instrument panel, increasing design freedom of the front portion of the passenger compartment.

The present disclosure can reduce space required for the on-vehicle equipment operation device.

### BRIEF DESCRIPTION OF THE DRAWINGS

Embodiments of the present disclosure will be described based on the following figures, wherein:

FIG. 1 is a perspective view of an on-vehicle equipment operation device according to one embodiment of the present disclosure;

FIG. 2 is a cross-sectional view of the on-vehicle equipment operation device according to the embodiment of the present disclosure;

FIG. 3 is a front view of icons displayed on a display of the on-vehicle equipment operation device according to the embodiment of the present disclosure; and

FIG. 4 is a cross-sectional view of an on-vehicle equipment operation device according to another embodiment of the present disclosure.

### DETAILED DESCRIPTION

An on-vehicle equipment operation device 100 according to an embodiment of the present disclosure is described below with reference to the attached drawings. Although in the description below the on-vehicle equipment operation device 100 is disposed at an instrument panel 11 at the front of a passenger compartment 10, the on-vehicle equipment operation device 100 may be disposed at any location. Arrows FR, UP, and RH in the drawings indicate the front, upward, and right directions of the vehicle, respectively. The opposite directions of arrows FR, UP, and RH are the rear, downward, and left directions of the vehicle. Unless otherwise indicated, when the description below refers simply to front, rear, right, left, upward, and downward, these references indicate the front, rear, right, left, upward, and downward directions relative to the vehicle, respectively.

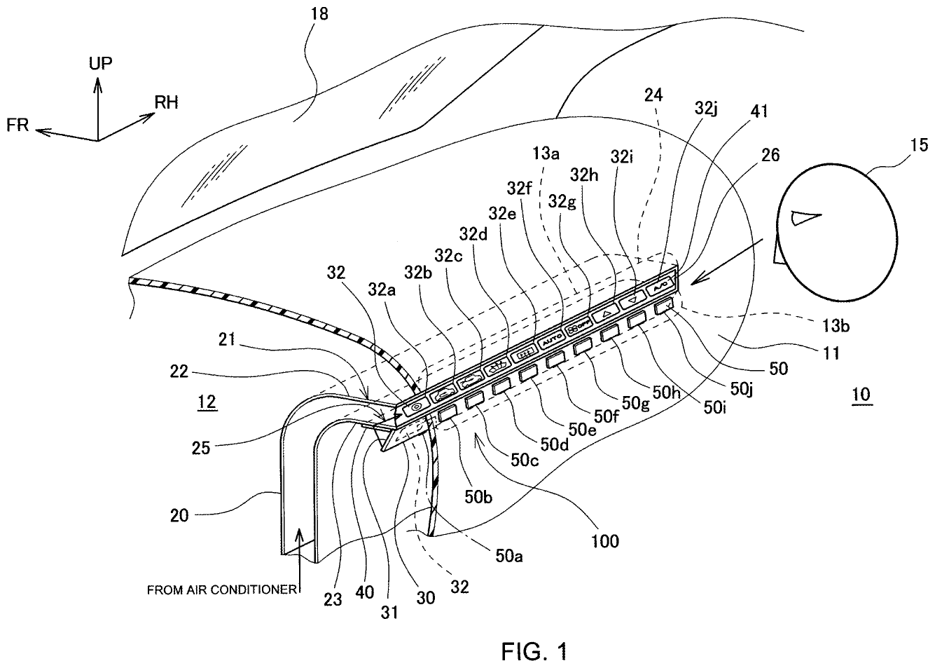

As shown in FIG. 1, the on-vehicle equipment operation device 100 includes a display 30, an image forming optical element 40, equipment operation switches 50, and an air-conditioning duct 20 that includes an open end 26. In FIG. 1, a left portion of the instrument panel 11 is omitted and the on-vehicle equipment operation device 100 disposed at the right of the instrument panel 11 is shown. In FIG. 1, the air-conditioning duct 20 is shown with a side wall 24 on the left omitted.

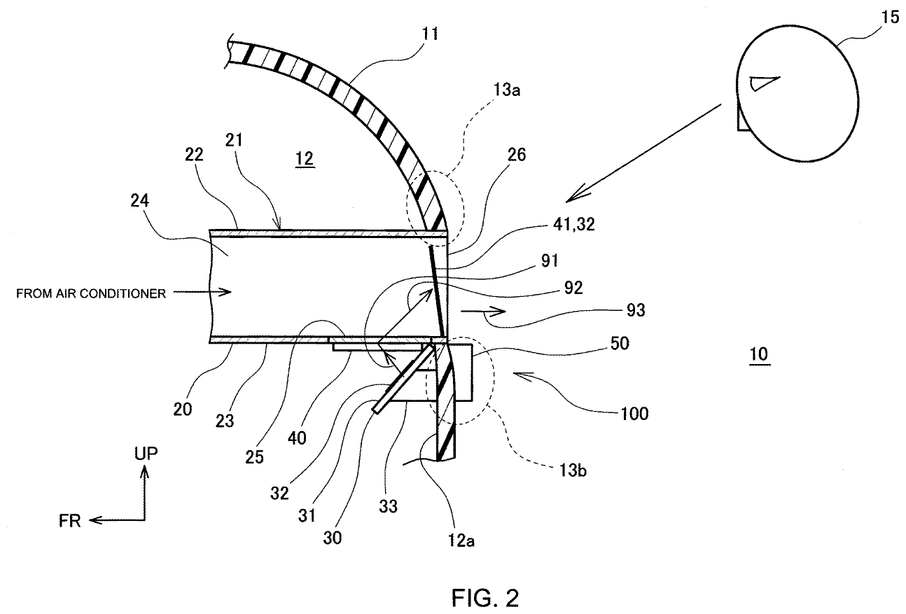

The air-conditioning duct 20 is connected to an on-vehicle air conditioner (not shown). The air-conditioning duct 20 includes the open end 26 through which the air-conditioned air from the air conditioner is blown as shown with arrow 93 in FIG. 2. The open end 26 is disposed at the instrument panel 11 at the front of the passenger compartment 10. A front glass 18 is provided in the vehicle front side of the instrument panel 11. A downstream end 21 at which the open end 26 of the air-conditioning duct 20 is disposed has a transversely elongated rectangular cross section that is defined with a top wall 22, a bottom wall 23, and a pair of side walls 24 on the right and left. The open end 26 has a transversely elongated slit shape.

As shown in FIG. 2, a part of the bottom wall 23 of the downstream end 21 includes, near the open end 26, a translucent wall 25 that includes a translucent member. The translucent wall 25 extends side-to-side of the duct between the pair of side walls 24 of the downstream end 21 of the air-conditioning duct 20. An image forming optical element 40 is attached to the bottom outer surface of the translucent wall 25. The width of the image forming optical element 40 is substantially equal to that of the open end 26. The image forming optical element 40 may have, for example, a dihedral corner reflector array structure in which discrete optical elements are arranged to split light beams into a number of beams and collects the split beams according to geometrical optics to form an image.

The display 30 is disposed at a vehicle location rearward of the image forming optical element 40. The display 30 is disposed adjacent to the image forming optical element 40 and fixed, with a bracket 33, to an inner wall 12a on an internal side 12 of the instrument panel 11 such that the image display surface 31 forms an angle with the outer surface of the bottom wall 23 of the air-conditioning duct 20. The display 30 has a transversely elongated shape with a width and height substantially equal to those of the open end 26.

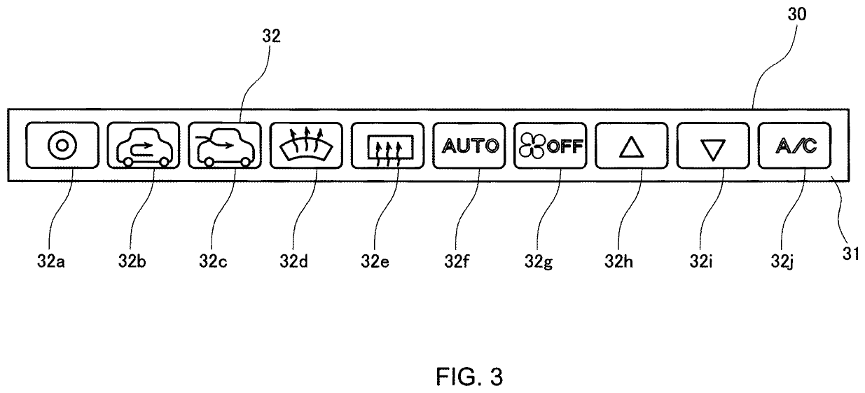

As shown in FIG. 3, multiple images of icons 32 that are used to operate the air conditioner (on-vehicle equipment) are displayed on the image display surface 31 of the display 30. The icons 32 represents the operations with a simple symbol and/or text. In description below, when there is no need to distinguish individual icons, the icons are simply referred to as “icon 32”, whereas when it is necessary to identify each icon, the icons are referred to as “icon 32a”, “icon 32b”, “icon 32c”, and so on with a corresponding letter added after the reference number “32”.

FIG. 3 shows 10 icons (icons 32a to 32j) that are aligned in a single line on the transversely elongated display 30. The leftmost icon 32a represents a switch to turn ON/OFF the air conditioner itself. The next two icons, icons 32b and 32c, represent switches to select internal air circulation or external air introduction. The icons 32d and 32e represent switches to turn ON/OFF a front or rear defroster. The icon 32f represents a switch to switch the air conditioner to an automatic operation mode. The icon 32g represents a switch to stop an air conditioner fan. The icons 32h and 32i represent switches to increase or decrease the temperature setting of the air conditioner. The icon 32j represents a switch to turn ON/OFF a cooling/heating operation of the air conditioner.

When the icons 32a to 32j are displayed on the image display surface 31 of the display 30 as shown in FIG. 3, light emitted from the image display surface 31 of the display 30 enters the image forming optical element 40 as shown with arrow 91 in FIG. 2. Light incident on the image forming optical element 40 propagates toward the open end 26 via the translucent wall 25 as shown with arrow 92 in FIG. 2. The image forming optical element 40 forms, as a floating image 41 near the open end 26, a real image of the icons 32a to 32j that are displayed on the image display surface 31 of the display 30. The floating image 41 includes the icons 32a to 32j aligned in a line from the left, as displayed on the display 30. An occupant 15 in the passenger compartment 10 can view the icons 32a to 32j displayed at the open end 26 of the air-conditioning duct 20.

As shown in FIG. 1, equipment operation switches 50 are aligned in a line on the instrument panel 11 along the lower edge 13b of the open end 26 that has a transversely elongated slit shape. In the description below, similarly to the icons 32, when there is no need to distinguish the individual equipment operation switches 50, the switches are simply referred to as “equipment operation switch 50”, whereas when it is necessary to identify each switch, the switches are referred to as “equipment operation switch 50a”, “equipment operation switch 50b”, “equipment operation switch 50c”, and so on with a corresponding alphabet added after the reference number “50”.

The equipment operation switches 50a to 50j are disposed below the corresponding icons 32a to 32j in the floating image 41 to perform operations represented by the respective icons 32a to 32j. The equipment operation switch 50a disposed below the leftmost icon 32a that represents a switch to turn ON/OFF the entire air conditioner turns ON/OFF the entire air conditioner. The next two switches, switches 50b and 50c, that are disposed below the icon 32b and the icon 32c for switching to internal air circulation or external air introduction switch to the internal air circulation or external air introduction, respectively. The remaining equipment operation switches similarly perform the operations as follows: the equipment operation switches 50d and 50e switch ON/OFF a front or rear defroster; the equipment operation switch 50f switches the air-conditioner to the automatic operation mode; the equipment operation switch 50g stops the air conditioner fan; the equipment operation switches 50h and 50j increase or decrease the temperature setting of the air conditioner, respectively; and the equipment operation switch 50j turns ON/OFF the cooling/heating operation of the air conditioner.

As described above, the on-vehicle equipment operation device 100 provides the floating image 41 that includes equipment operation icons 32a to 32j, and equipment operation switches 50a to 50j that correspond to the equipment operation icons 32a to 32j, respectively. The floating image 41 is formed near the open end 26 of the air-conditioning duct 20. The equipment operation switches 50a to 50j are disposed on the instrument panel 11 below the lower edge 13b of the open end 26. The occupant 15 in the passenger compartment 10 views, in the floating image 41, the icons 32a to 32j disposed at the open end 26 of the air-conditioning duct 20. In order to perform an operation corresponding to one of the icons 32, the desired operation can be performed by activating the corresponding equipment operation switch 50 that is disposed below the icon 32. For example, in order to activate internal air circulation, the air conditioner can be switched to the internal air circulation by activating the equipment operation switch 50b below the icon 32b for switching to the internal air circulation. When the equipment operation switch 50c below the icon 32c for switching to the external air introduction is activated, the air conditioner switches to the external air introduction.

Various types of switches may be used for the equipment operation switches 50. For example, by configuring infrared switches to be activated when the occupant 15 places one of his/her fingers near to the icon 32, the occupant 15 may feel as though the occupant 15 were operating the icon 32 in the floating image 41. In such a case, the equipment operation switches 50 may be disposed along an upper edge 13a of the open end 26.

Alternatively, touch switches may be used for the equipment operation switches 50. In this case, as described above, the occupant 15 may easily operate the equipment operation switches 50 with the touch switches disposed along the lower edge 13b of the open end 26. Mechanical pushbutton switches may also be used for the equipment operation switches 50.

As described above, the on-vehicle equipment operation device 100 provides the floating image 41 that is formed near the open end 26 of the air-conditioning duct 20 and the equipment operation switches 50a to 50j provided on the instrument panel 11 along the lower edge 13b of the open end 26. The floating image 41 includes the equipment operation icons 32a to 32j, and the equipment operation switches 50a to 50j correspond to these icons, respectively. Because the same space can be used in common both for displaying the equipment operation icons 32a to 32j and for disposing the open end 26 of the air-conditioning duct 20, space can be saved, enhancing freedom of design of the passenger compartment 10.

As the equipment operation switches 50a to 50j are aligned in a single line on the instrument panel 11 along the lower edge 13b of the open end 26 that has a transversely elongated shape, the occupant 15 can easily operate the equipment operation switches 50a to 50j.

Further, as the image forming optical element 40 and the display 30 are disposed outside the air-conditioning duct 20, a possible deterioration of the image forming optical element 40 and the display 30 due to a temperature change or humidity in the air-conditioned air can be reduced.

Although the on-vehicle equipment operation device 100 is described above as a device to operate the air conditioner that is installed in a vehicle, the present disclosure is not limited to such embodiments and may be applied to operate any other on-vehicle equipment. For example, the operation device may be configured for an on-vehicle audio device by providing icons 32 for operating an audio device, such as a radio, and corresponding equipment operation switches 50.

Although the open end 26 of the air-conditioning duct 20 described above has a transversely elongated slit shape and the icons are described as aligned in a single transverse line in the floating image 41, the present disclosure is not limited to such embodiments. For example, the open end 26 may be rectangular or square, and the floating image 41 may include icons 32 which are aligned in two rows, and the equipment operation switches 50 may be disposed along the upper edge 13a and the lower edge 13b of the open end 26. In yet another embodiment, the open end 26 may have a vertically elongated slit shape and the icons 32 may be displayed in three rows in the floating image 41. In such a case, the equipment operation switches 50 may be disposed along the side edges of the open end 26. The icons 32 that are displayed at the open end 26 may be a single icon and the corresponding switch may be a single equipment operation switch 50.

Although the on-vehicle equipment operation device 100 is described above to be disposed on the instrument panel 11 at the front of the passenger compartment 10, the on-vehicle equipment operation device 100 may be disposed at the rear of a center console that includes an air outlet that blows air toward rear seats.

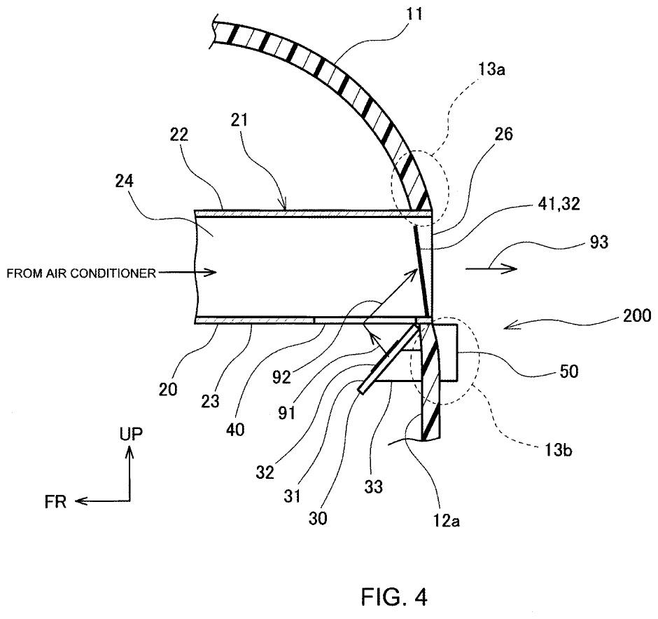

An on-vehicle equipment operation device 200 according to another embodiment is described below with reference to FIG. 4. The elements that are similar to those of the on-vehicle equipment operation device 100 described above with reference to FIGS. 1 to 3 are represented by the same reference numerals and their description is not repeated.

The on-vehicle equipment operation device 200 differs from the on-vehicle equipment operation device 100 in that the on-vehicle equipment operation device 200 includes, in place of the translucent wall 25 that is described above as a part of the bottom wall 23 of the air-conditioning duct 20 of the on-vehicle equipment operation device 100, the image forming optical element 40 that extends along the vehicle side-to-side direction between the pair of the side walls 24 of the downstream end 21. The length of the image forming optical element 40 along the vehicle side-to-side direction is substantially equal to that of the open end 26. The image forming optical element 40 is part of the bottom wall 23 of the air-conditioning duct 20.

Light emitted from the image display surface 31 of the display 30 enters the image forming optical element 40 as shown with arrow 91 in FIG. 4. Then, light incident on the image forming optical element 40 propagates toward the open end 26 as shown with arrow 92 in FIG. 4. The image forming optical element 40 forms, as the floating image 41 near the open end 26, a real image of the icons 32a to 32j that are displayed on the image display surface 31 of the display 30.

Similarly as with the on-vehicle equipment operation device 100, because the on-vehicle equipment operation device 200 uses the same common space both for displaying the equipment operation icons 32a to 32j and for disposing the open end 26 of the air-conditioning duct 20, space can be conserved, enhancing freedom of design of the passenger compartment 10. Furthermore, because no translucent wall 25 is required for the on-vehicle equipment operation device 200, a simpler configuration can be achieved.

1. An on-vehicle equipment operation device that operates equipment installed in a vehicle, the on-vehicle equipment operation device comprising:
an air-conditioning duct connected to an air conditioner of the vehicle, the air-conditioning duct comprising an open end through which air-conditioned air from the air conditioner blows into a passenger compartment;
a display disposed outside the air conditioner and configured to display an image;
an image forming optical element attached to the air-conditioning duct, and configured to form, as a floating image near the open end of the air-conditioning duct, a real image of the image displayed on the display; and
at least one equipment operation switch disposed at a perimeter of the open end of the air-conditioning duct,
wherein the floating image comprises at least one equipment operation icon, and
the at least one equipment operation switch corresponds to the at least one equipment operation icon.

2. The on-vehicle equipment operation device according to claim 1, wherein
the floating image comprises a plurality of equipment operation icons,
the at least one equipment operation switch is a plurality of equipment operation switches disposed at the perimeter of the open end of the air-conditioning duct,
the plurality of equipment operation switches correspond to the plurality of equipment operation icons respectively.

3. The on-vehicle equipment operation device according to claim 2, wherein
the open end of the air-conditioning duct has a transversely-elongated slit shape, and
the plurality of equipment operation switches are disposed in a line along an upper edge or a lower edge of the open end.

4. The on-vehicle equipment operation device according to claim 1, wherein
the air-conditioning duct comprises a translucent wall that comprises a translucent member,
the image forming optical element is disposed on an outer surface of the translucent wall, and
the display is disposed adjacent to and on a vehicle rear side of the image forming optical element such that the display forms an angle with an outer surface of the air-conditioning duct.

5. The on-vehicle equipment operation device according to claim 2, wherein
the air-conditioning duct comprises a translucent wall that comprises a translucent member,
the image forming optical element is disposed on an outer surface of the translucent wall, and
the display is disposed adjacent to and on a vehicle rear side of the image forming optical element such that the display forms an angle with an outer surface of the air-conditioning duct.

6. The on-vehicle equipment operation device according to claim 3, wherein
the air-conditioning duct comprises a translucent wall that comprises a translucent member,
the image forming optical element is disposed on an outer surface of the translucent wall, and
the display is disposed adjacent to and on a vehicle rear side of the image forming optical element such that the display forms an angle with an outer surface of the air-conditioning duct.

7. The on-vehicle equipment operation device according to claim 1, wherein
the image forming optical element is part of a wall of the air-conditioning duct.

8. The on-vehicle equipment operation device according to claim 2, wherein
the image forming optical element is part of a wall of the air-conditioning duct.

9. The on-vehicle equipment operation device according to claim 3, wherein
the image forming optical element is part of a wall of the air-conditioning duct.

10. The on-vehicle equipment operation device according to claim 4, wherein
the open end of the air-conditioning duct is disposed at an instrument panel at a front portion of the passenger compartment,
the display is disposed behind the front instrument panel, and
the at least one equipment operation switch is disposed on the instrument panel at the open end.

11. The on-vehicle equipment operation device according to claim 5, wherein
the open end of the air-conditioning duct is disposed at an instrument panel at a front portion of the passenger compartment,
the display is disposed behind the front instrument panel, and
the at least one equipment operation switch is disposed on the instrument panel at the open end.

12. The on-vehicle equipment operation device according to claim 6, wherein
the open end of the air-conditioning duct is disposed at an instrument panel at a front portion of the passenger compartment,
the display is disposed behind the front instrument panel, and
the at least one equipment operation switch is disposed on the instrument panel at the open end.

13. The on-vehicle equipment operation device according to claim 7, wherein
the open end of the air-conditioning duct is disposed at an instrument panel at a front portion of the passenger compartment,
the display is disposed behind the front instrument panel, and
the at least one equipment operation switch is disposed at the instrument panel at the open end.

14. The on-vehicle equipment operation device according to claim 8, wherein
the open end of the air-conditioning duct is disposed at an instrument panel at a front portion of the passenger compartment,
the display is disposed behind the front instrument panel, and
the at least one equipment operation switch is disposed at the instrument panel at the open end.

15. The on-vehicle equipment operation device according to claim 9, wherein
the open end of the air-conditioning duct is disposed at an instrument panel at a front portion of the passenger compartment,
the display is disposed behind the front instrument panel, and
the at least one equipment operation switch is disposed at the instrument panel at the open end.
